(19) United States
(12) Patent Application Publication
(10) Pub. No.: US 2023/0042010 A1
(43) Pub. Date: Feb. 9, 2023

(54) PLUG FOR ELECTRONIC PLUCKED STRING INSTRUMENT AND CABLE WITH PLUG FOR ELECTRONIC PLUCKED STRING INSTRUMENT

(71) Applicant: TRI-SOUND INC., Tokyo (JP)

(72) Inventor: Daiya TEZUKA, Tokyo (JP)

(21) Appl. No.: 17/789,077

(22) PCT Filed: Oct. 23, 2020
(86) PCT No.: PCT/JP2020/039817

§ 371 Date: Oct. 24, 2022

(30) Foreign Application Priority Data
Dec. 26, 2019 (JP) 2019-236265

(51) Int. Cl. G10H 1/32; G10H 3/18; H01R 24/38

(52) U.S. Cl. CPC G10H 1/32; G10H 3/186; H01R 24/38; H01R 13/595

(57) ABSTRACT

The invention provides a plug for an electronic plucked string instrument having a structure for fixing with a set screw by inserting a cable into a sleeve in a plug side. A biting convex portion biting into an insulated outer sheath while receiving a screwing compression force of a set screw via a cable is formed integrally on an inner peripheral surface of an attachment sleeve in a plug side along a peripheral direction of a sleeve inner peripheral surface. The biting convex portion formed on the inner peripheral surface of the attachment sleeve in the plug bites into the insulated outer sheath of the cable. Thus, a slip displacement against a sleeve inner surface of the cable is inhibited by the biting convex portion and a slack of the set screw can be effectively suppressed even in a case where a stronger tensile force is applied to the cable.

### TECHNICAL FIELD

The invention relates to a plug which is used for an electronic plucked string instrument such as an electric guitar, and a cable to which the plug is attached.

### BACKGROUND ART

An eleelectric bass detects a waveform signal of a musical performance sound which is generated by a string vibration, by a pickup buried in a musical instrument main body, sends the waveform signal to an amplifier by a cable which is drawn out of the musical instrument main body to amplify it, and outputs an amplified musical performance sound from a speaker connected to the amplifier. Connection between the cable and the amplifier is achieved by insertion of a plug provided in a cable end to a jack provided in the musical instrument main body, in a case of a general electronic plucked string instrument. Most of the plugs mentioned above have a sleeve (a tubular portion) for attaching the cable in a rear end side, achieves an electric connection by inserting a leading end of the cable thereto and soldering, and is configured to fix the cable by screwing a set screw to the sleeve inward in a radial direction from an outer side thereof (for example, Patent Literature 1).

### CITATION LIST

### Patent Literature

Patent Literature 1: Japanese Utility Model No. 3154676

### SUMMARY OF INVENTION

### Technical Problem

In the meantime, the electronic plucked string instrument as mentioned above is frequently played by a player while being held by hands as is different from a keyboard instrument, and a player may violently swing a musical instrument particularly in a case of a musical performance in a rock or pops music. As a result, an external load tends to be constantly applied to a plug which connects the cable to the musical instrument. In particular, a tensile force is repeatedly applied to the cable, the cable slips and displaces in an axial direction to an inner surface of a sleeve against a clamping force of a set screw, and there is a problem that a slack of the set screw tends to be generated. When the slack of the set screw is increased, the force for fixing the cable to the sleeve is lost, thereby causing an event that a soldered portion is broken and the cable falls out of the plug.

In the patent literature 1, there has been made a suggestion that a fixation slack of a cable is suppressed by setting the number of the set screws for screwing into the sleeve to be two or more. However, an inner peripheral surface of the sleeve coming into contact with an insulated outer sheath of the cable is flat, and is no different in a configuration that the cable tends to slips and displaces against the inner surface of the sleeve when the tensile force is applied. Therefore, the same problem may be generated in a case where an instantaneous tensile force is repeatedly applied or a stronger tensile force is applied.

An object of the present invention is to provide a plug for an electronic plucked string instrument having a structure for fixing with a set screw by inserting a cable into a sleeve in a plug side and configured to prevent the cable from being slipped and displaced against the sleeve even in a case where a greater tensile force is applied, and a cable to which the plug is attached.

### Solution to Problem

The present invention relates to a plug for an electronic plucked string instrument which is used by being attached to an end of a cable for connecting the cable to a music sound output terminal of the electronic plucked string instrument, and a cable with plug for the electronic plucked string instrument. In order to achieve the object mentioned above, the present invention is provided with a plug main body which is formed into such a shape as to engage with a musical instrument side jack forming a music sound output terminal, an attachment sleeve which is formed into such a cylindrical shape as to be open in both ends in an axial direction, is integrated with a rear end side of the plug main body, and allows a leading end portion of the cable to be inserted in the axial direction from a rear end side opening to an inner side, and a set screw which is screwed into a peripheral wall portion of the attachment sleeve in such a manner that a leading end comes into contact with an insulated outer sheath of the cable while passing through the attachment sleeve in a radial direction, and clamps the cable with respect to a peripheral wall portion of the cable on the basis of a screwing compression force caused by the screwing, wherein a biting convex portion biting into the insulated outer sheath while receiving the screwing compression force of the set screw via the cable is integrally formed on an inner peripheral surface of the attachment sleeve along a peripheral direction of the inner peripheral surface.

Further, the cable with plug for the electronic plucked string instrument according to the present invention includes the plug for the electronic plucked string instrument according to the present invention, and a cable which is inserted into and fixed to the attachment sleeve of the plug for the electronic plucked string instrument.

In the present invention mentioned above, the biting convex portion biting into the insulated outer sheath while receiving the screwing compression force of the set screw via the cable is integrally formed on the inner peripheral surface of the attachment sleeve in the plug side along the peripheral direction. In other words, the inner peripheral surface of the attachment sleeve in the plug side is not flat at the position where the inner peripheral surface receives the screwing compression force of the set screw as is different from the patent literature, but the biting convex portion formed on the inner peripheral surface is configured to bite into the insulated outer sheath. Thus, the slip displacement of the cable against the inner surface of the attachment sleeve is blocked by the biting convex portion even in a case where the stronger tensile force is applied to the cable or the tensile force is repeatedly applied to the cable. As a result, it is possible to effectively suppress the slack of the set screw.

The cable may be configured as a coaxial shielded cable which has a shielded conductor layer in an inner side of the insulated outer sheath, and in which a core wire is arranged in an inner side of the shielded conductor layer via an intermediate insulation layer. In this case, the set screw may be configured to be electrically conduction contacted with the shielded conductor layer through the insulated outer sheath. As mentioned above, the biting convex portion bites into the insulated outer sheath while receiving the screwing compression force of the set screw via the cable. The plug main body may include a rod-like main metal fitting which is conduction connected to a core wire of the cable, and a grounding metal fitting which is arranged in an outer side of the main metal fitting via the insulation layer in the plug, and the attachment sleeve may be integrally connected to a rear end side of the grounding metal fitting via the connecting conductor. In this case, the shielded conductor layer of the cable may be solder bonded to the connecting conductor. In the patent literature 1, the conduction between the shielded conductor layer of the coaxial shielded cable and the grounding metal fitting is formed only by the mechanical contact between the set screw passing through the insulated outer sheath and the shielded conductor layer, and the conduction between the grounding metal fitting and the shielded conductor layer is immediately deteriorated in a case where any slack is generated in the set screw. As a result, an electrostatic shielding effect applied to the core wire flowing the music sound signal therethrough and generated by the shielded conductor layer becomes insufficient, thereby causing a noise mixing into the music sound signal.

However, by employing the structure in which the shielded conductor layer is solder bonded to the connecting conductor in the plug side in addition to the structure in which the set screw and the shielded conductor layer are conduction contacted, as mentioned above, the grounding conduction of the shielded conductor layer can be sufficiently secured by the solder bonding to the connecting conductor in the grounding metal fitting side even if the set screw is slacked, and the problem mentioned above can be made hard to be generated. Further, in a case of the present invention, the biting convex portion formed in the attachment sleeve in the plug side bites into the insulated outer sheath of the cable. As a result, the set screw is inherently hard to be slacked even if the tensile force is repeatedly applied to the cable, and the conduction state between the shielded conductor layer and the grounding metal fitting can be maintained to be extremely well for a long term period of time.

Next, in a case where a strong torsional moment is applied to the cable, the insulated outer sheath of the cable may slip and displace along a peripheral direction of the sleeve, and a slack in the set screw may be easily generated. The problem mentioned above can be effectively prevent or suppressed by forming a slip displacement stopping portion for inhibiting the biting convex portion from relatively slipping and displacing in a peripheral direction in a state in which the biting convex portion bites into the insulated outer sheath on an inner peripheral surface of the attachment sleeve. The slip displacement stopping portion can be formed by partially notching the inner peripheral surface of the attachment sleeve in the peripheral direction. In this structure, the insulated outer sheath of the cable is pressed into the slip displacement stopping portion outward in a radial direction, and an insulated outer sheath press-fit portion is formed. As a result, it is possible to effectively inhibit the relative slip displacement of the cable in the peripheral direction against the attachment sleeve.

### Effect of the Invention

The details of the operations and the effects of the present invention have been already described in “SOLUTION TO PROBLEM”, and will not be described repeatedly.

### BRIEF DESCRIPTION OF DRAWINGS

FIG. 1 is a view showing a state in which an electric guitar is connected to an amplifier by a cable with plug for an electronic plucked string instrument according to an embodiment of the present invention.

FIG. 2 is a view showing a state in which a plug cover is attached to the cable with plug for the electronic plucked string instrument.

FIG. 3 is a perspective view showing a state in which a plug for the electronic plucked string instrument according to an embodiment of the present invention is overviewed from a front side.

FIG. 4 is a perspective view showing a state in which the plug for the electronic plucked string instrument is overviewed from a rear side.

FIG. 5 is a plan view, a bottom elevational view and a front elevational view showing a detailed structure of the plug for the electronic plucked string instrument in FIG. 3.

FIG. 6 is a side elevational view of the same.

FIG. 7 is a side elevational cross sectional view along a line A-A in FIG. 5.

FIG. 8 is a cross sectional view along a line B-B in FIG. 6.

FIG. 9 is an explanatory view showing an example of a structure of a coaxial shielded cable.

FIG. 10 is a plan view showing a state in which the coaxial shielded cable in FIG. 9 is attached to the plug for the electronic plucked string instrument in FIG. 3.

FIG. 11 is a front elevational cross sectional view and a side elevational cross sectional view showing a main part in FIG. 10 in an enlarged manner.

FIG. 12 is an enlarged front elevational cross sectional view showing an operation of a protruding streak portion and a notched concave portion.

FIG. 13 is an enlarged side elevational cross sectional view showing an operation of the protruding streak portion and the notched concave portion.

FIG. 14 is an explanatory view of an operation in a cross section along a line D-D in FIG. 11.

FIG. 15 is an explanatory view of a step of attaching the coaxial shielded cable in FIG. 9 to the plug for the electronic plucked string instrument in FIG. 3.

FIG. 16 is an explanatory view following FIG. 15.

FIG. 17 is a cross sectional view showing a first modified example of the protruding streak portion.

FIG. 18 is a cross sectional view showing a second modified example of the protruding streak portion.

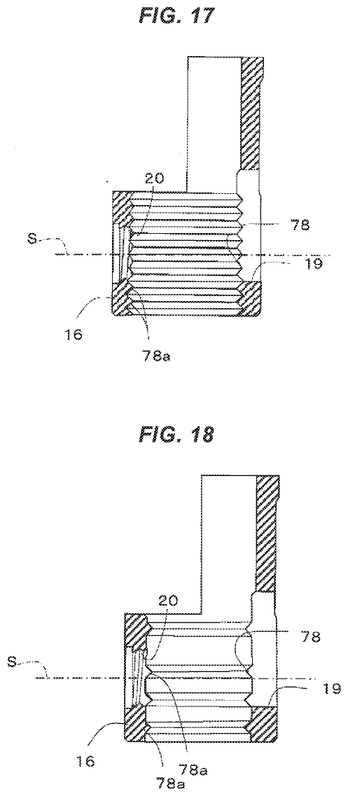

FIG. 17 is a cross sectional view showing a third modified example of the protruding streak portion together with an operation thereof.

FIG. 20 is an explanatory view showing a first modified example of the biting convex portion.

FIG. 21 is a cross sectional view showing a second modified example of the biting convex portion.

FIG. 22 is an explanatory view showing a modified example of the notched convex portion together with an operation thereof.

FIG. 23 is a front elevational cross sectional view showing a main part of a plug in which a plurality of set screws are provided.

FIG. 24 is a front elevational cross sectional view showing a main plug in which the notched concave portion is omitted together with an operation thereof.

FIG. 25 is a front elevational cross sectional view of a main part of the other example of the plug in which the notched concave portion is omitted.

FIG. 26 is a cross sectional view showing a fourth modified example of the protruding streak portion.

FIG. 27 is a cross sectional view showing a fifth modified example of the protruding streak portion.

FIG. 28 is a side elevational cross sectional view showing a main part of a plug according to a reference example.

### DESCRIPTION OF EMBODIMENTS

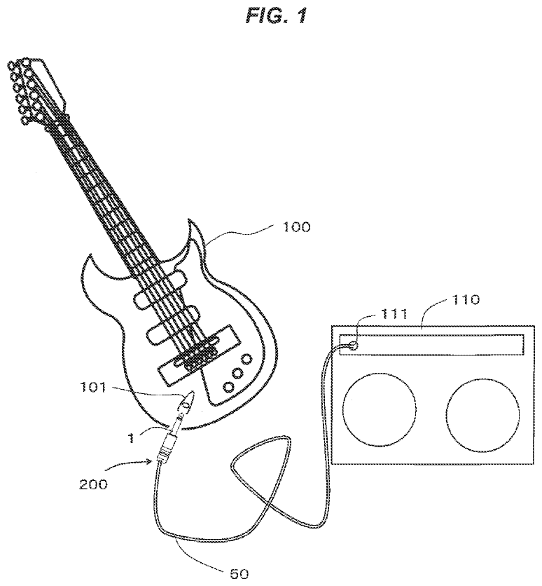

FIG. 1 shows a state in which an electric guitar 100 corresponding to an electronic plucked string instrument is connected to an amplifier by a cable with plug 200 for an electronic plucked string instrument according to an embodiment of the present invention. The cable with plug 200 for the electronic plucked string instrument has a cable 50, and a plug 1 for the electronic plucked string instrument (hereinafter, refer simply to as “plug 1”) which is attached to one end thereof. In FIG. 1, a musical instrument side jack 101 forming a music sound output terminal is formed in a lower portion of a front surface (or a lower portion of a side surface) in a body portion of the electric guitar 100, and a cable 50 is connected thereto by inserting the plug 1 into the musical instrument side jack 101. A connector 111 is formed in the other end side of the cable 50, and is connected to a terminal of the amplifier 110 side. The electronic plucked string instrument to be applied is not limited to the electric guitar, but may be the other plucked string instrument such as an electric bass and an electric sham isen.

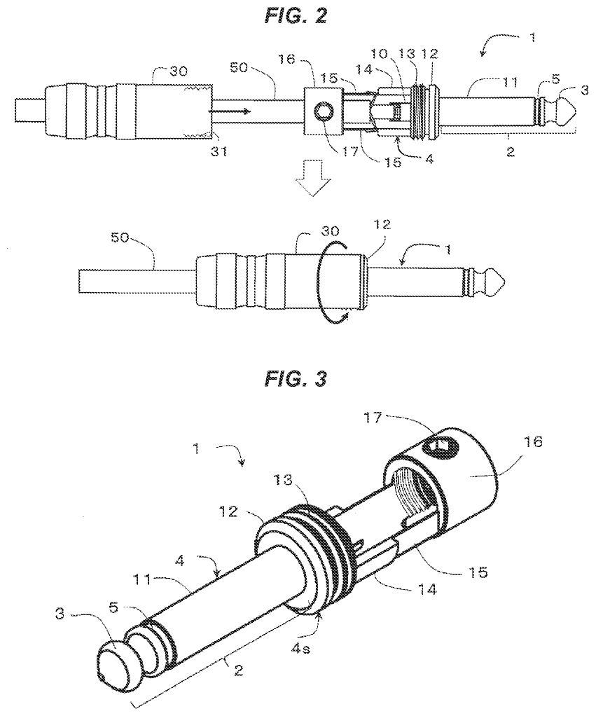

As shown in FIG. 2, the plug 1 has a grounding metal fitting 4 which includes a rear portion of a plug main body 2, and a male thread portion 13 and a stopper flange 12 are formed on an outer peripheral surface of the plug. A connected portion between the cable 50 and the plug 1 is covered with a tubular plug cover 30. The plug cover 30 is fixed to the plug 1 in a state in which a front end edge thereof is brought into contact with and stopped at the stopper flange 12, by threadably mounting a female thread portion 31 formed on an inner peripheral surface of a front end portion to the male thread portion 13 in the plug 1 side.

The plug main body 2 is formed, for example, as a well-known phone plug having such a shape as to be defined in JIS: C6560 (1994), and has such a shape as to be engaged with the musical instrument side jack 101. An attachment sleeve 16 is integrated with a rear end side of the plug main body 2, the attachment sleeve 16 being open in both ends in an axial direction and formed into a cylindrical shape. A leading end portion of a cable 50 is inserted in an axial direction into an inner side of the attachment sleeve 16 from a rear end side opening, and is fixed by a set screw 17. The set screw 17 is screwed into a peripheral wall portion of the attachment sleeve 16 in a state in which a leading end surface comes into contact with an insulated outer sheath 51 of the cable 50 while passing through the peripheral wall portion in a radial direction, and holds the cable 50 so as to clamp the cable 50 with respect to the peripheral wall portion on the basis of a screwing compression force generated by screwing.

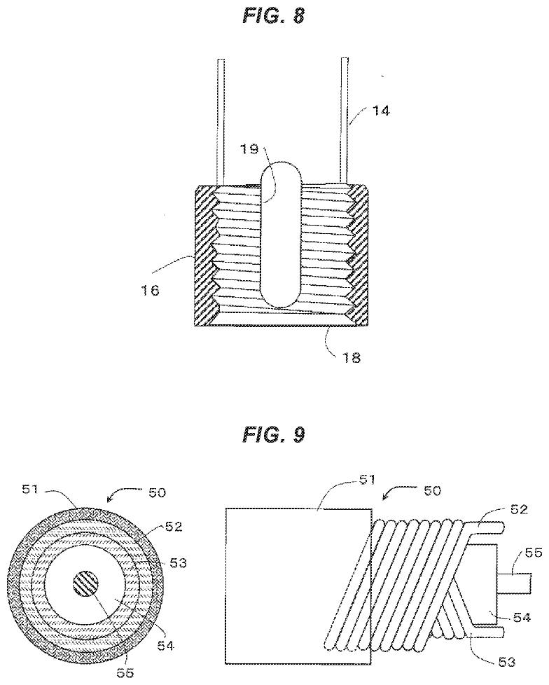

FIG. 9 shows an example of a structure of the cable 50. The cable 50 is constructed as a coaxial shielded cable which has shielded conductor layers 52 and 53 in an inner side of an insulated outer sheath 51, and has a core wire 55 arranged in an inner side of the shielded conductor layers 52 and 53 via an intermediate insulation layer 54. In the present embodiment, the shielded conductor layers 52 and 53 are constructed by a first layer 52 and a second layer 53, and are both formed as a winding wire portion in which a conducting wire is wound around an outer side of the intermediate insulation layer 54 in a close contact state. In the first layer 52 and the second layer 53, winding directions of the conducting wires are opposite to each other, and an electrostatic shielding effect applied to the core wire 55 through which the music sound signal current flows is enhanced.

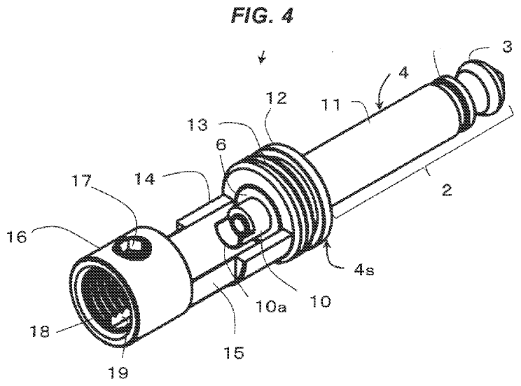

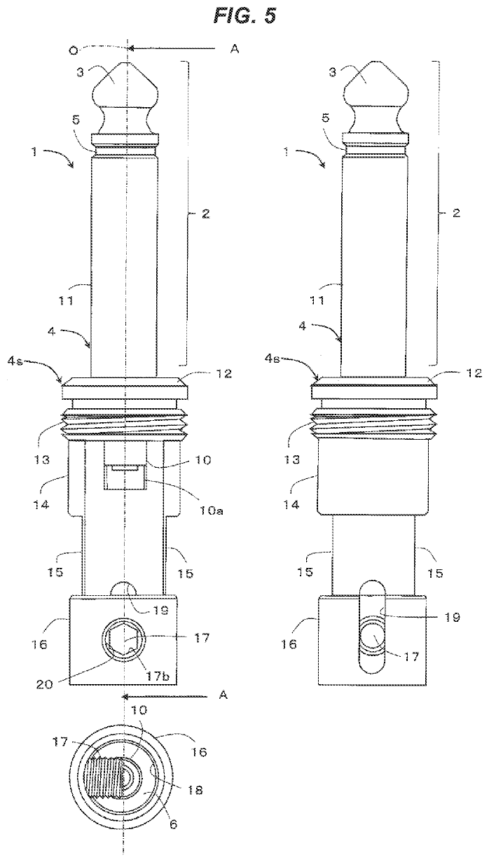

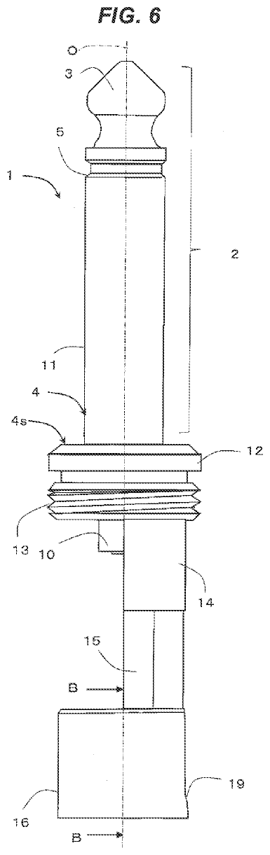

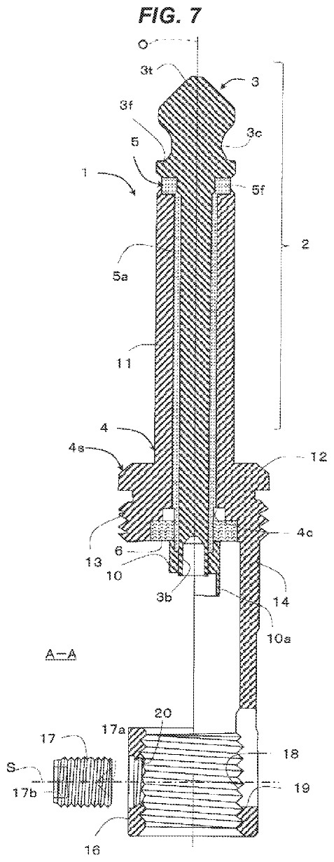

A description will be further in detail given below of the structure of the plug 1 with reference to FIGS. 3 to 8. FIG. 3 is a perspective view in a case where the plug 1 is overviewed from a front side in an axial direction, and FIG. 4 is a perspective view in a case where the plug 1 is overviewed from a rear side in the axial direction. FIG. 5 is a plan view, a bottom elevational view and a front elevational view showing a detailed structure of the plug 1, and FIG. 6 is a side elevational view of the same. Further, FIG. 7 is a side elevational cross sectional view of the plug 1 according to a cross section along a line A-A in FIG. 5, and FIG. 8 is a cross sectional view along a line B-B in FIG. 6.

As shown in the cross sectional view in FIG. 7, the plug main body 2 is provided with a rod-like main metal fitting 3, and a grounding metal fitting 4 which is arranged in an outer side of the main metal fitting 3 via a plug side insulation layer 5. A leading end portion 3tof the main metal fitting 3 has an engagement concave portion 3c engaging with a musical instrument side jack in a side surface thereof, and a flange portion 3f is integrally formed at the rear side of the engagement concave portion 3 c in a direction of an axis O. On the other hand, the grounding metal fitting 4 is formed into a tubular shape, and the main metal fitting 3 is inserted from a rear end thereof in such a manner as to clamp the tubular plug side insulation layer 5 in the direction of the axis O from a front end side opening of the grounding metal fitting 4. An insulation flange 5f formed in a leading end portion of the tubular plug side insulation layer 5 is sandwiched between a rear end surface of the flange portion 3f of the main metal fitting 3 and a front end surface of the grounding metal fitting 4. The plug side insulation layer 5 is formed as an injection molded body of a resin having a self-lubricating property, for example, a polyacetal resin.

A stem portion 4s having a larger diameter than the plug main body 2 is formed in the grounding metal fitting 4, the stopper flange 12 mentioned above is formed in a front end portion of an outer peripheral surface of the stem portion 4s, and a male thread portion 13 is formed in a rear end portion of the outer peripheral surface of the stem portion 4s. Further, a counterbore portion 4c is formed in a rear end surface of the stem portion 4s, and a rear end portion of the main metal fitting 3 inserted inside protrudes into the counterbore portion 4c together with the plug side insulation layer 5, and is fixed by an insulating ring 6 (made of a heat resistant resin, for example, Bakelite) fitted into the counterbore portion 4c. Further, a rear end portion of the main metal fitting 3 protrudes out of the insulating ring 6 to a rear side, and a ring-shaped terminal metal fitting 10 is fitted to an outer side thereof in a conduction state (refer also to FIG. 4). A semi-tubular solder receiving portion 10a is integrated with a rear end surface of the terminal metal fitting 10 in a protruding state. Further, a core wire insertion hole 3b is formed in an opening manner in a rear end surface of the main metal fitting 3.

Further, as shown in FIGS. 3 and 4, a cylindrical attachment sleeve 16 is integrally connected to a rear end surface of the stem portion 4s via a connecting conductor 14. The connecting conductor 14 is formed into a semi-tubular shape which is open in one side with respect to the axis O of the plug 1, and is notched flat in both sides of an outer side surface in a rear end side (a side to which the attachment sleeve 16 is connected), as shown in FIG. 5, so that a pair of soldered surfaces 15 and 15 are formed (refer also to FIGS. 3 and 4).

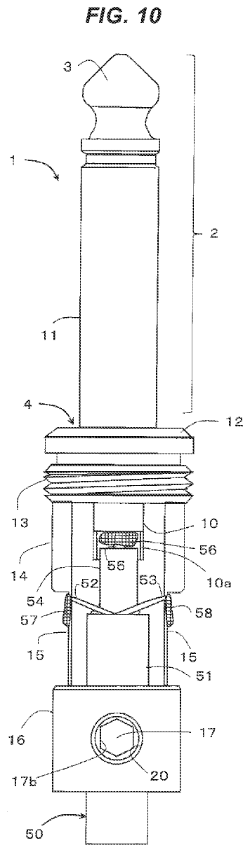

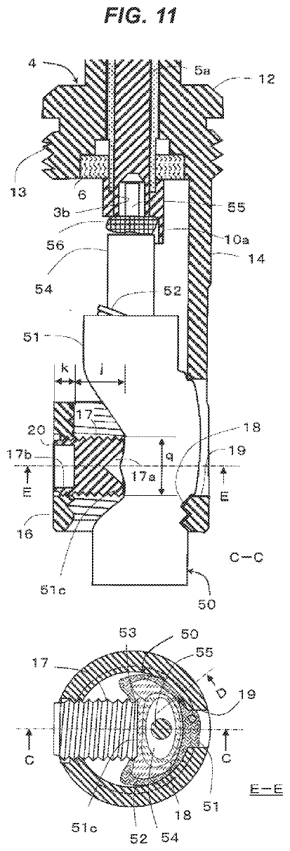

FIG. 10 is a plan view showing a state in which the cable 50 is attached to the plug 1, and FIG. 11 is a side elevational cross sectional view showing a main part of the same. As shown in a right view of FIG. 9, in a leading end side of the cable 50, an insulated outer sheath 51 is stripped so that the shielded conductor layers 52 and 53 are exposed, and a leading end portion of the intermediate insulation layer 54 is further stripped in the same manner, so that the core wire 55 is exposed. As shown in FIG. 11, the core wire 55 is inserted into the core wire insertion hole 3b in a rear end surface of the terminal metal fitting 10, and a molten solder is poured into a gap between the leading end surface of the intermediate insulation layer 54 and the rear end surface of the terminal metal fitting 10, so that a soldered portion conduction connecting the core wire 55 and the terminal metal fitting 10 is formed. The soldering is executed in a state in which the plug 1 is horizontally put in such a manner that an opening side of the connecting conductor 14 is an upper side, and the solder receiving portion 10a plays a role of increasing a soldered surface area as well as preventing the molten solder from falling down. In the meantime, as shown in FIG. 10, the exposed shielded conductor layers 52 and 53 are drawn out in a state in which the leading end portions of the respective winding coils of the first layer 52 and the second layer 53 are allocated to left and right, and are respectively connected to the corresponding soldered surfaces 15 and 15 by soldered portions 57 and 58.

The materials of the main metal fitting 3 and the grounding metal fitting 4 are constructed by metals, more specifically, a copper alloy such as brass, phosphor bronze or beryllium copper, and a plating for preventing a corrosion or improving a conductive property is applied to surfaces of the main metal fitting 3 and the grounding metal fitting 4. The plated layer is specifically constructed by a nickel plated layer and a chrome plated layer, and a gold plating may be applied to a top layer portion for further improving an electric conductive property. In the grounding metal fitting 4, the stem portion 4s, the connecting conductor 14 and the attachment sleeve 16 are integrally formed by a cutting process of a metal rod member. In order to prevent the set screw 17 from being slacked, a rigidity of the attachment sleeve 16 is preferably higher. In this regard, the grounding metal fitting 4 is desirably constructed by the phosphor bronze or the beryllium copper having a high tensile strength. The beryllium copper has a particularly high strength, and is advantageous in the light of preventing the slack of the set screw 17. Since the beryllium copper is a precipitation hardening type alloy, a necessary rigidity can be secured by applying a precipitation strengthening heat treatment after executing a cutting process in a state of a solution treated material.

Next, as shown in FIGS. 7 and 10 (refer also to FIGS. 3 and 4), in the grounding metal fitting 4, a female thread hole 20 passing through a peripheral wall portion of the cylindrical attachment sleeve 16 in a radial direction is formed in the cylindrical attachment sleeve 16 which is connected to a rear and side of the connecting conductor 14, and the set screw 17 is screwed into the female thread hole 20.

As shown in FIG. 11, the set screw 17 protrudes to an inner side of the attachment sleeve 16 in a leading end side of a leg portion, and holds the cable 50 on the basis of a screwing compression force caused by screwing while clamping the cable 50 with respect to the peripheral wall portion of the attachment sleeve 16. In the present embodiment, the set screw 17 is constructed as a slotted set screw, a concave portion 17a is formed in an end surface in a side coming into contact with the cable 50, and a tool engagement hole 17b for engaging a tool such as a hexagonal wrench is formed in an end surface in an opposite site.

In the present embodiment, only one set screw 17 is provided, and as shown in a cross section along a line E-E in FIG. 11, the cable 50 is retained within the attachment sleeve 16 while being compressed and deformed into an approximately heart-shaped cross sectional form in such a manner that a concave portion 51c is generated at a contact position with the set screw 17. In particular, a leading end of the set screw 17 passes through the insulated outer sheath 51, and is electrically conducted and contacted with the shielded conductor layer 52. This contact is formed mechanically without being soldered. On the other hand, the biting of the leading end of the set screw 17 does not reach the intermediate insulation layer 54, and the insulation between the core wire 55 and the shielded conductor layers 52 and 53 is secured.

Further, the insulated outer sheath 51 of the cable 50 partly bites into the concave portion 17a of the set screw 17. The shape of the leading end of the set screw 17 is not limited to this, but may be formed, for example, into a conical shape (or a shape that the leading end side is offset into a rounded form or a flat form). Further, the material of the set screw 17 is, for example, a stainless steel.

Further, in an area where the cable 50 is in contact in an inner peripheral surface of the attachment sleeve 16, in an opposite side to the side with which the set screw 17 comes into contact, a biting convex portion 18 extending along a peripheral direction of the inner peripheral surface is integrally formed. The biting convex portion 18 receives the screwing compression force of the set screw 17 via the cable 50, and allows a part thereof to bite into the insulated outer sheath 51.

As mentioned above, the inner peripheral surface of the attachment sleeve 16 in the plug side is not formed into the flat shape as is different from the patent literature 1 at the position where it receives the screwing compression force of the set screw 17, but is configured to allow the biting convex portion 18 formed in the inner peripheral surface to bite into the insulated outer sheath 51. Thus, even in a case where the stronger tensile force is applied to the cable 50, the slip displacement of the cable 50 against the inner surface of the attachment sleeve 16 is blocked by the biting convex portion 18, and it is possible to effectively suppress the slack of the set screw 17.

As shown in FIG. 10, the shielded conductor layers 52 and 53 of the cable 50 are conduction connected to the connecting conductor 14 by the soldered portions 57 and 58. By adding the structure for solder bonding the shielded conductor layers 52 and 53 to the connecting conductor 14 in the plug side in addition to the structure for bringing the set screw 17 into conduction contact with the shielded conductor layer 52, the grounding conduction of the shielded conductor layer 52 is sufficiently secured by the solder bonding to the grounding metal fitting 4 even if the set screw 17 is loosened, thereby making the problem that the electrostatic shielding effect is deteriorated by the shielded conductor layers 52 and 53 to the core wire 55 through which the music sound signal flows hard to be generated. This effect can be achieved in the same manner even in an aspect which does not employ the structure according to the present invention, for example, an aspect in which the biting convex portion is not formed in the inner surface of the attachment sleeve 16, such as a reference example shown in FIG. 28. However, the slack of the set screw 17 is inherently hard to be generated by employing the structure according to the present invention. Therefore, the conduction state between the shielded conductor layer 52 and the grounding metal fitting 4 can be well maintained for a long term period of time.

The biting convex portion 18 is electrically insulated from the shielded conductor layers 52 and 53 via the insulated outer sheath 51 while biting into the insulated outer sheath 51. The material of the insulated outer sheath 51 is an insulating resin, for example, vinyl chloride, and a friction force acting between the biting convex portion 18 and the insulated outer sheath 51 has a function of suppressing the slip displacement in the peripheral direction in addition to a function of suppressing the slip displacement in the axial direction against the inner surface of the attachment sleeve 16 in the cable 50. For example, in a case where the biting convex portion 18 is formed into a protruding streak portion mentioned later, when the protruding streak portion is configured to pass through the insulated outer sheath 51 and come into contact with the shielded conductor layers 52 and 53, the protruding streak portion and the shielded conductor layers 52 and 53 form a contact between the metals and a friction resistance becomes small. As a result, when the torsional moment acts on the cable 50, the slip displacement in the peripheral direction against the protruding streak portion may be easily generated. However, in a case where the biting of the protruding streak portion stays in the inner portion of the insulated outer sheath 51 as mentioned above, both the elements form the contact between the metal and the resin and the friction resistance becomes great. Therefore, there is an advantage that the slip displacement in the peripheral direction of the cable 50 against the protruding streak portion is harder to be generated.

The dimension of each of the portions in the plug 1 is not particularly limited, however, for example, a total length thereof is 60 mm, and the plug main body 2 has an outer diameter of 6.3 mm and an axial length of 30.5 mm. An inner diameter of the attachment sleeve 16 may change in correspondence to an outer diameter of the cable 50 to be used, however, may be set in a range, for example, between 10 mm and 15 mm (in the present embodiment, for example, 10.5 mm), and a thickness of a side wall portion thereof is set between 1 mm and 2 mm (in the present embodiment, 1.4 mm).

Here, in a case where a cable 50 having an outer diameter slightly smaller than the inner diameter of the attachment sleeve 16 is wanted to be used, a protruding length j of the set screw 17 from the inner peripheral surface of the attachment sleeve 16 is frequently greater than a thickness k of the peripheral wall portion of the attachment sleeve 16 as shown in FIG. 11. In a case of the structure mentioned above, when the slip displacement of the cable 50 against the attachment sleeve 16 is generated, a moment of the force acting at a position of a protruding base end from the inner peripheral surface in the set screw 17 becomes great, the collapse of the set screw 17 causing the slack particularly tends to be generated. Therefore, the effect of the present invention contributing to the slip displacement prevention of the cable 50 is particularly remarkably achieved.

Further, a nominal thread diameter q of the set screw 17 is set to be greater than the thickness k of the peripheral wall portion in the sleeve. Thus, even in a case where the great tensile force or torsion force acts on the cable 50, the collapse of the set screw 17 within the sleeve is hard to be generated, and it is possible to further effectively suppress the slack of the set screw 17. An upper limit value of the nominal thread diameter q of the set screw 17 is not particularly limited as long as the formation of the female thread hole 20 for the attachment sleeve 16 is not prevented, for example, can be set to be smaller than the outer diameter of the cable 50.

The number of the set screw 17 screwed into the attachment sleeve 16 may be set to two (or more), for example, as shown in FIG. 23. However, the parts number can be reduced by setting the number to one as shown in FIG. 11, and it is possible to achieve a simplification of the plug structure. The biting convex portion 18 is at least partly formed at a position where the biting convex portion 18 overlaps a projection domain in the axial direction of the set screw 17 in the leading end surface of the set screw 17 for the inner peripheral surface of the attachment sleeve 16. Thus, it is possible to securely receive the screwing compression force from the set screw 17 by the leading end surface of the set screw 17, and it is possible to more stably clamp the cable 50 between the set screw 17 and the biting convex portion 18.

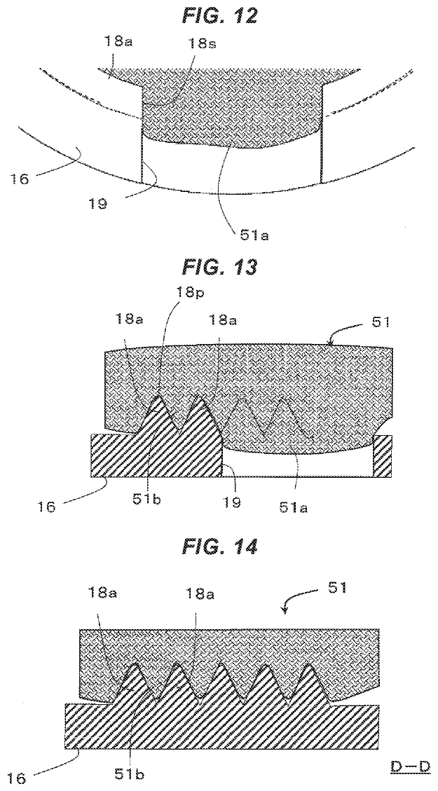

In the present embodiment, the biting convex portion 18 formed on the inner peripheral surface of the attachment sleeve 16 is formed as a protruding streak portion 18a which is formed along the peripheral direction, as shown in FIGS. 12 to 14. Thus, the biting length of the biting convex portion 18 in the peripheral direction with respect to the insulated outer sheath 51 of the cable 50 is further enlarged, and it is possible to further enhance the effect of suppressing the slip displacement of the cable 50 with respect to the attachment sleeve 16. Further, since the biting force of the biting convex portion 18 with respect to the insulated outer sheath 51 is dispersed, the trouble that the biting convex portion 18 passes through the insulated outer sheath 51 is hard to be generated. A plural rows of protruding streak portions are formed in the inner peripheral surface along the axial direction of the attachment sleeve 16, and the effect mentioned above is accordingly enhanced more.

In particular, as shown in FIG. 11, the protruding streak portion (the biting convex portion 18) is formed over a whole circumference of the inner peripheral surface of the attachment sleeve 16 (except a region where a notched concave portion 19 mentioned later is formed). The protruding streak portion as mentioned above has an advantage that it is easily formed by a cutting process. In a case where the plural rows of protruding streak portions expanding over the whole periphery are formed in the attachment sleeve 16, the plural rows or protruding streak portions can be formed by a continuous cutting process when a plural windings of protruding streak portions are continuously formed into a spiral shape in an axial direction, thereby further efficiently formed. In the present embodiment, the spiral protruding streak portion is formed as a female thread portion which is narrowed toward the inner side in the radial direction. FIG. 13 shows an enlarged part of a cross section along a line C-C in FIG. 11. In the protruding streak portion 18a formed as the female thread portion, a biting depth of a screw thread portion with respect to the insulated outer sheath 51 is more enlarged, and the slip displacement suppressing effect of the cable 50 with respect to the attachment sleeve 16 is further enhanced. In a case where it is desired that the protruding streak portion 18a is electrically insulated from the shielded conductor layers 52 and 53 via the insulated outer sheath 51 while biding into the insulated outer sheath 51, a leading end 18p of the protruding streak portion 18a may be formed into a chamfered shape or a rounded shape, as shown in FIG. 13.

Turning back to FIG. 11, in a case where the strong torsional moment acts on the cable 50, the insulated outer sheath 51 of the cable 50 may slip and displace along the peripheral direction of the attachment sleeve 16, and the slack of the set screw 17 may be easily generated. In particular, in a case where the protruding streak portion (the biting convex portion 18) is formed over a whole circumference of the inner peripheral surface of the attachment sleeve 16 as mentioned above, the insulated outer sheath 51 of the cable 50 may slip and displace along the sleeve peripheral direction, that is, the longitudinal direction of the protruding streak portion when the strong torsional moment acts on the cable 50. Accordingly, in the present embodiment, the slip displacement stopping portion is provided for inhibiting the protruding streak portion (the biting convex portion 18) from slipping and displacing relatively in the peripheral direction in a state in which it bites into the insulated outer sheath 51.

More specifically, the slip displacement stopping portion is formed as the notched concave portion 19 which is formed by partly notching the protruding streak portion (the biting convex portion 18) at the intermediate position in the peripheral direction as shown in FIG. 8. As shown in FIGS. 12 and 13, the insulated outer sheath 51 of the cable 50 is pressed into the notched concave portion 19 outward in the radial direction, and an insulated outer sheath press-fit portion 51a is formed. In particular, as shown in FIG. 12, a notch end 18s of the protruding streak portion 18a comes into contact with the insulated outer sheath press-fit portion 51a, so that the relative slip displacement of the cable 50 in the peripheral direction with respect to the attachment sleeve 16 is effectively inhibited. As shown in FIG. 14, all of the plural rows of protruding streak portions 18a generates the biting with respect to the insulated outer sheath 51 in a region where the notched concave portion 19 is not formed in the inner peripheral surface of the attachment sleeve 16.

The notched concave portion 19 is formed as a notched through hole which passes through the peripheral wall portion of the attachment sleeve 16 in the radial direction. Thus, the deep notched concave portion 19 can be easily formed as the notched through hole by means of the cutting process from the outer peripheral surface side of the attachment sleeve 16, and a formed height of the insulated outer sheath press-fit portion 51a formed by being bitten thereinto can be enlarged. As a result, it is possible to further enhance the effect of suppressing the relative slip displacement.

As shown in FIG. 8, the notched concave portion 19 is formed astride two or more of the protruding streak portions which are formed in the plural rows in the axial direction. Thus, as shown in FIG. 13, the insulated outer sheath press-fit portion 51a is also formed astride two or more of the protruding streak portions, and it is possible to further effectively suppress the relative slip displacement of the cable 50 in the peripheral direction with respect to the attachment sleeve 16. In particular, in a case where the protruding streak portion is formed into the spiral shape such as the female thread portion mentioned above, the screwing force in the axial direction may be generated for the cable 50 from the spiral protruding streak portion, the set screw 17 may receive a strong collapsing displacement force in the axial direction, and the slack may be more easily generated. Therefore, it can be said to be particularly effective to suppress the relative slip displacement of the cable 50 in the peripheral direction with respect to the attachment sleeve 16 by forming the notched concave portion 19 mentioned above.

In FIG. 11, only one set screw 17 is screwed into the attachment sleeve 16, and the notched concave portion 19 is formed at a position overlapping with the projection domain of the set screw 17 in the axial direction on the leading end surface of the set screw 17 with respect to the inner peripheral surface of the attachment sleeve 16. Thus, it is possible to enhance the biting force of the insulated outer sheath 51 into the notched concave portion 19, and it is possible to more remarkably form the insulated outer sheath press-fit portion 51a.

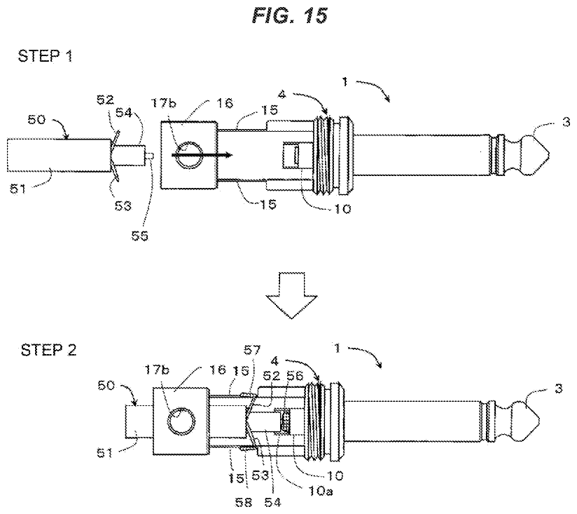

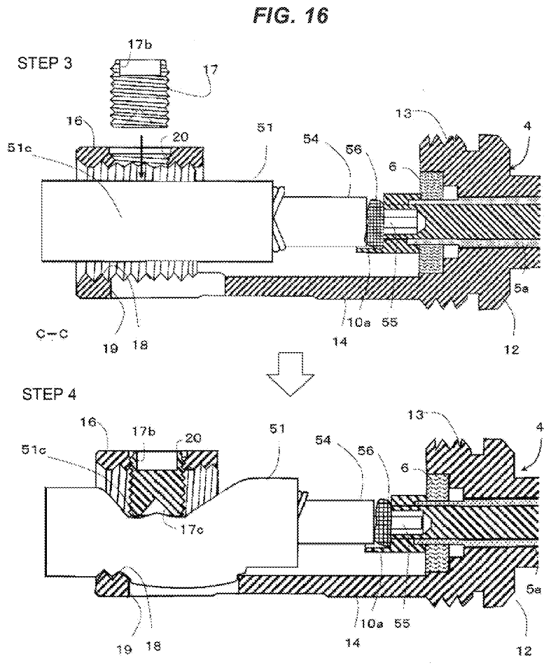

A step of assembling the cable 50 in the plug 1 is as follows. More specifically, the leading end portion of the cable 50 to which a stripping is applied as shown in FIG. 9 is inserted into the inner side of the attachment sleeve 16 of the plug 1 in a state in which the set screw 17 is detached (or evacuated) such as a step 1 in FIG. 15, and an electric connection between the plug 1 and the cable 50 is performed by forming the soldered portions 56 to 58 described by FIG. 10 such as a step 2. Subsequently, the set screw 17 is installed to the female thread hole 20 of the attachment sleeve 16 such as a step 3 in FIG. 16, and an assembly is finished by engaging and fastening a tool (not shown) such as a hexagonal wrench with the tool engagement hole 17b such as a step 4.

The description is given above of the embodiments of the plug for the electronic plucked string instrument according to the present invention, however, the present invention is not limited to these embodiments. A description will be given below of various modified examples according to the present invention with reference to FIGS. 17 to 27 (same reference numerals are attached to portions which are conceptually in common with those of the embodiments mentioned above, and a detailed description thereof will be omitted). FIG. 17 shows an example that the plural rows of protruding streak portions (biting convex portions) formed in the attachment sleeve 16 are not spirally integrated, but a protruding streak portion 78a closed in a circular ring shape in the peripheral direction is formed to be close contact in the axial direction. Since the plurality of protruding streak portions 78a are not integrated, a cutting bite is evacuated inward from the inner peripheral surface of the attachment sleeve 16 to pitch feed the attachment sleeve 16, and the next protruding streak portion 78a is cut in a case where the protruding streak portion 78a is formed by cutting the inner peripheral surface of the attachment sleeve 16. Therefore, the larger number of processing steps are required in comparison with the case where the spiral protruding streak portion is formed. However, since the screwing reaction force is not generated from the protruding streak portion in a case where the torsion force is applied to the cable, there is an advantage that the collapse of the set screw is hard to be generated.

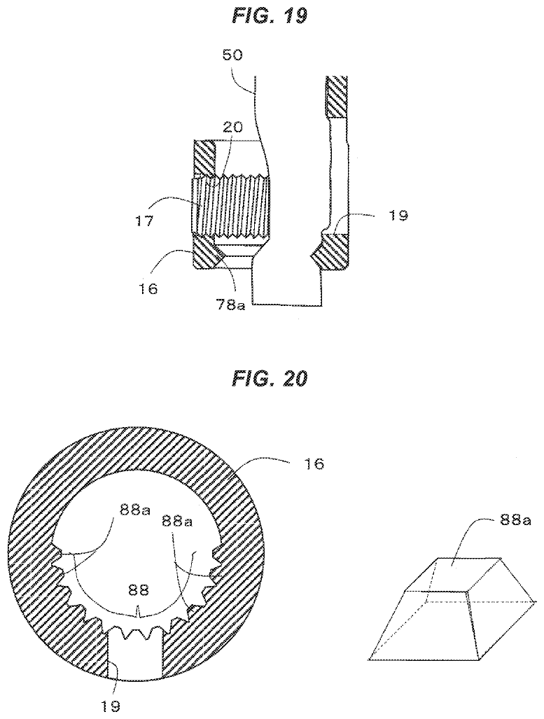

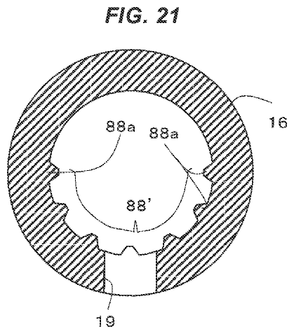

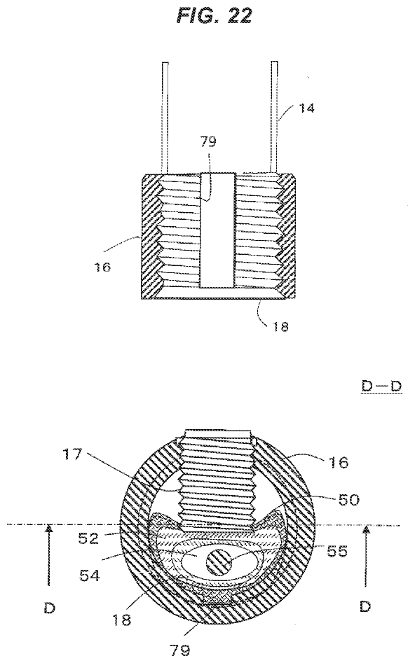

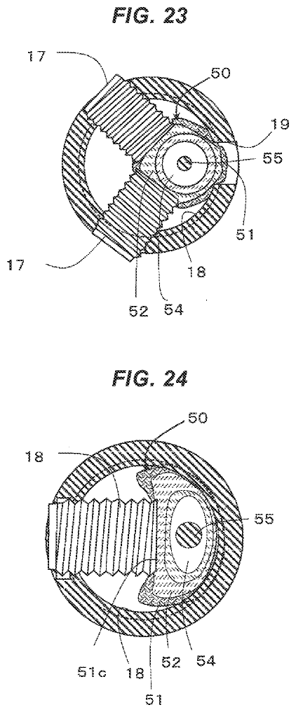

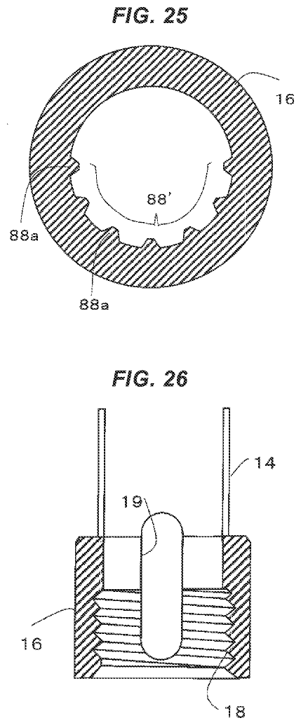

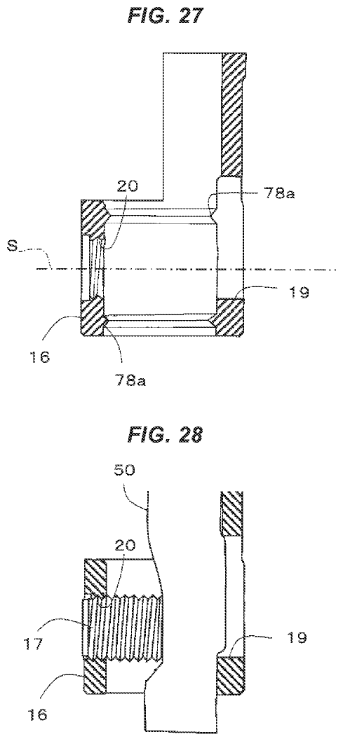

Further, in the structure shown in FIG. 7, the protruding streak portion 18 (the biting convex portion) is formed over a whole region in the axial direction of the sleeve for the inner peripheral surface of the attachment sleeve 16, however, the protruding streak portion may be formed only a partial region in the axial direction of the sleeve. For example, FIG. 26 is an example in which the protruding streak portion 18 is formed in a region from a first end side (a lower side in the drawing) to an intermediate position in the axial direction of the sleeve for the inner peripheral surface of the attachment sleeve 16. FIG. 18 shows an example in which the circular ring-shaped protruding streak portions 78a are formed at predetermined intervals in the axial direction of the sleeve. FIG. 19 shows an example in which the circular ring-shaped protruding streak portion 78a is formed only at one row on the inner peripheral surface of the attachment sleeve 16, specifically only in a first end side (a lower side in the drawing) in the axial direction of the sleeve. FIG. 27 shows an example in which the circular ring-shaped protruding streak portion 78a is formed in two rows on the inner peripheral surface of the attachment sleeve 16, specifically in a first end side (a lower side in the drawing) and a second end side (an upper side in 10he drawing) in the axial direction of the sleeve.

In the light of unifor0mly receiving the screwing compression force generated by the set screw 17 by a plurality of protruding streak portions, it is desirable to form the protruding streak portions 18 so as to allocate to both side with regard to an axis S of the set screw in the axial direction of the sleeve for the inner peripheral surface of the attachment sleeve 16, as shown in FIG. 7. By employing the structure mentioned above, it is possible to make a problem that an excessive biting force acts on a particular protruding streak portion and the insulated outer sheath 51 is broken hard to be generated. The same effect can be achieved in the structures in FIGS. 17, 18, 22 and 27.

Further, in FIG. 20, the biting convex portion 88 is formed as the assembly of a plurality of biting projections 88a which are intermittently arranged along the peripheral direction of the attachment sleeve 16. The biting convex portion 88 mentioned above may be provided in only one row in the axial direction of the attachment sleeve 16, or may be provided in plural rows. As shown in a right side of FIG. 20 in an enlarged manner, the biting projection 88a may be formed into a truncated pyramid shape or a circular truncated cone shape. Further, FIG. 21 is an example in which the biting projections 88a mentioned above are formed at intervals in the peripheral direction. In the structures in FIGS. 20 and 21, an air gap between the adjacent biting projections 88a and 88a in the peripheral direction functions as a slip displacement stopping portion.

The biting convex portions 88 as shown in FIGS. 20 and 21 are hard to be formed by cutting, however, can be manufactured by casting according to a lost-wax process or a sintering method using a Metal Injection Mold (MIM) method.

FIG. 22 shows an example in which the slip displacement stopping portion is formed as a bottomed groove portion 79 in which only the protruding streak portion (the biting convex portion) is notched in place of the through hole. FIG. 23 shows an embodiment in a case where a plurality of set screws 17 are provided as mentioned above.

Further, FIG. 24 shows a structure in which the notched concave portion 19 is omitted from the aspect in FIG. 11. In a case where the structure is used under an environment that the load applied to the cable 50 is mainly constituted by the tensile force and the torsion force is comparatively hard to be applied, it is possible to sufficiently suppress the slack of the set screw 17 on the basis of the present structure. Further, FIG. 25 shows a structure in which the notched concave portion 19 is omitted from the aspect in FIG. 21. In the present structure, the air gap between the adjacent biting projections 88a and 88a in the peripheral direction functions as the slip displacement stopping portion. Therefore, there is generated an advantage that the slack of the set screw 17 is hard to be generated even in an environment that the torsion force tends to be applied to the cable 50.

The present patent application is based on Japanese Patent Application No. 2019-236265 filed on Dec. 26, 2019, and the contents thereof are included here for reference.

### REFERENCE SIGNS LIST

1 plug for electronic plucked string instrument

2 plug main body

3 main metal fitting

3b core wire insertion hole

3 c engagement concave portion

3f flange portion

3tleading end portion

4 grounding metal fitting

4c counterbore portion

4s stem portion

5 plug side insulation layer

5f insulation flange

6 insulating ring (made of heat resistant resin, for example, Bakelite)

10 terminal metal fitting

10a solder receiving portion

11 connector

12 stopper flange

13 male thread portion

14 connecting conductor

15 soldered surface

16 attachment sleeve

17 set screwp

17a concave portion

17b tool engagement hole

18 biting convex portion

18a protruding streak portion

18s notch end

19 notched concave portion

20 female thread hole

30 plug cover

31 female thread portion

50 cable

51 insulated outer sheath

51a insulated outer sheath press-fit portion

51c concave portion

52, 53 shielded conductor layer

54 intermediate insulation layer

55 core wire

56 to 58 soldered portion

78a protruding streak portion

79 groove portion

88 biting convex portion

88a biting projection

100 electric guitar

101 musical instrument side jack

110 amplifier

200 cable

1. A plug for an electronic plucked string instrument attached to an end of a cable connecting to a music sound output terminal of the electronic plucked string instrument, the plug comprising:
a plug main body formed into such a shape as to engage with a musical instrument side jack forming a music sound output terminal;
an attachment sleeve formed into a cylindrical shape as to be open in both ends in an axial direction, is integrated with a rear end side of the plug main body, and allows a leading end portion of the cable to be inserted in the axial direction from a rear end side opening to an inner side; and
a set screw screwed into a peripheral wall portion of the attachment sleeve in such a manner that a leading end comes into contact with an outer sheath of the cable while passing through the attachment sleeve in a radial direction, and clamps the cable with respect to a peripheral wall portion of the cable on the basis of a screwing compression force caused by the screwing,
wherein a biting convex portion biting into the outer sheath while receiving the screwing compression force of the set screw via the cable is integrally formed on an inner peripheral surface of the attachment sleeve along a peripheral direction of the inner peripheral surface.

2. The plug for the electronic plucked string instrument according to claim 1, wherein a protruding length of the set screw from the inner peripheral surface of the peripheral wall portion is set to be greater than a thickness of the peripheral wall portion.

3. The plug for the electronic plucked string instrument according to claim 1, wherein a nominal thread diameter of the set is set to be greater than a thickness of the peripheral wall portion and smaller than an outer diameter of the cable.

4. The plug for the electronic plucked string instrument according to claim 1, wherein the number of the set screw screwed into the attachment sleeve is one, and at least a part of the biting convex portion is formed at a position overlapping with a projection domain of a leading end of the set screw with respect to an inner peripheral surface of the attachment sleeve in an axial direction of the set screw.

5. The plug for the electronic plucked string instrument according to claim 1, wherein the biting convex portion formed on the inner peripheral surface of the attachment sleeve is a protruding streak portion which is formed along the peripheral direction.

6. The plug for the electronic plucked string instrument according to claim 5, wherein the protruding streak portion is formed in plural rows on the inner peripheral surface along the axial direction of the attachment sleeve.

7. The plug for the electronic plucked string instrument according to claim 5, wherein the protruding streak portion is formed over a whole circumference of the inner peripheral surface of the attachment sleeve.

8. The plug for the electronic plucked string instrument according to claim 7, wherein plural windings of the protruding streak portions are formed into a spiral shape connecting in the axial direction.

9. The plug for the electronic plucked string instrument according to claim 8, wherein the spiral protruding streak portion is formed as a female thread portion which is narrowed toward an inner side in a radial direction.

10. The plug for the electronic plucked string instrument according to claim 1, wherein a slip displacement stopping portion is formed on the inner peripheral surface of the attachment sleeve, the slip displacement stopping portion being provided for inhibiting the biting convex portion from relatively slipping and displacing in the peripheral direction in a state in which the biting convex portion bites into the outer sheath when a torsional moment acts on the cable.

11. The plug for the electronic plucked string instrument according to claim 10, wherein the biting convex portion is a protruding streak portion which is formed along the peripheral direction, the slip displacement stopping portion is a notched concave portion which is formed by partly notching the protruding streak portion at an intermediate position in a peripheral direction, an outer sheath press-fit portion is formed by pressing the outer sheath of the cable outward in a radial direction into the notched concave portion, and the slip displacement is inhibited by the contact of a notch end of the protruding streak portion with the outer sheath press-fit portion.

12. The plug for the electronic plucked string instrument according to claim 10, wherein the slip displacement stopping portion is formed as a notched through hole which passes through the peripheral wall portion of the attachment sleeve in a radial direction.

13. The plug for the electronic plucked string instrument according to claim 10, wherein the number of the set screw screwed into the attachment sleeve is one, and the slip displacement stopping portion is formed at a position overlapping with a projection domain of a leading end of the set screw in the axial direction of the set screw for the inner peripheral surface of the attachment sleeve.

14. The plug for the electronic plucked string instrument according to claim 10, wherein the slip displacement stopping portion is formed astride two or more of the biting convex portions which are formed in plural rows in the axial direction.

15. A cable with plug for an electronic plucked string instrument comprising:
a plug for the electronic plucked string instrument attached to the end of the cable for connecting the cable to a music sound output terminal of the electronic plucked string instrument:
a plug main body formed into such a shape as to engage with a musical instrument side jack forming a music sound output terminal;
an attachment sleeve formed into a cylindrical shape as to be open in both ends in an axial direction, is integrated with a rear end side of the plug main body, and allows a leading end portion of the cable to be inserted in the axial direction from a rear end side opening to an inner side;
a set screw screwed into a peripheral wall portion of the attachment sleeve in such a manner that a leading end comes into contact with an outer sheath of the cable while passing through the attachment sleeve in a radial direction, and clamps the cable with respect to a peripheral wall portion of the cable on the basis of a screwing compression force caused by the screwing;
wherein a biting convex portion biting into the outer sheath while receiving the screwing compression force of the set screw via the cable is integrally formed on an inner peripheral surface of the attachment sleeve along a peripheral direction of the inner peripheral surface; and
the cable inserted into and fixed to the attachment sleeve of the plug for the electronic plucked string instrument.

16. The cable with plug for the electronic plucked string instrument according to claim 15, wherein the cable has a shielded conductor layer in an inner side of the insulated outer sheath, and is a coaxial shielded cable in which a core wire is arranged in an inner side of the shielded conductor layer via an intermediate insulation layer, the set screw passes through the insulated outer sheath and is electrically in conduction contact with the shielded conductor layer, and the biting convex portion bites into the insulated outer sheath while receiving the screwing compression force of the set screw via the cable,
wherein the plug main body comprises a rod-shaped main metal fitting which is conducted and connected to the core wire of the cable, and a grounding metal fitting which is arranged in an outer side of the main metal fitting via a plug side insulation layer, and the attachment sleeve is integrally connected to a rear end side of the grounding metal fitting via a connecting conductor, and
wherein a shielded conductor layer of the cable is solder bonded to the connecting conductor.
